(19) United States
(12) Patent Application Publication
(10) Pub. No.: US 2015/0380963 A1
(43) Pub. Date: Dec. 31, 2015

(54) Charging Assembly

(71) Applicant: Jeremy Scalchunes, Brookville, NY (US)

(72) Inventor: Jeremy Scalchunes, Brookville, NY (US)

(21) Appl. No.: 14/317,724

(22) Filed: Jun. 27, 2014

(51) Int. Cl. H02J 7/00; H04M 19/08; H04M 1/725

(52) U.S. Cl. CPC H02J 7/0044; H04M 1/72522; H04M 19/08

(57) ABSTRACT

A charging assembly for drawing electricity from a first electronic device and delivering the electricity to a second electronic device includes a first coupler that may be coupled to the first electronic device. A second coupler may be coupled to the second electronic device. A controller is coupled between the first and second couplers. The controller controls the transfer of electricity between the first and second electronic devices. A processor is coupled to the controller. A display is coupled to the controller. The display is operationally coupled to the processor. The display displays an amount of charge that is transferred between the first and second electronic devices.

### BACKGROUND OF THE DISCLOSURE

### Field of the Disclosure

The disclosure relates to charging devices and more particularly pertains to a new charging device for drawing electricity from a first electronic device and delivering the electricity to a second electronic device.

### SUMMARY OF THE DISCLOSURE

An embodiment of the disclosure meets the needs presented above by generally comprising a first coupler that may be coupled to a first electronic device. A second coupler may be coupled to a second electronic device. A controller is coupled between the first and second couplers. The controller controls the transfer of electricity between the first and second electronic devices. A processor is coupled to the controller. A display is coupled to the controller. The display is operationally coupled to the processor. The display displays an amount of charge that is transferred between the first and second electronic devices.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a charging assembly according to an embodiment of the disclosure.

FIG. 2 is an in-use view of an embodiment of the disclosure.

FIG. 3 is a right side view of an embodiment of the disclosure.

FIG. 4 is a top view of an embodiment of the disclosure.

FIG. 5 is a schematic view of an embodiment of the disclosure.

### DESCRIPTION OF THE PREFERRED EMBODIMENT

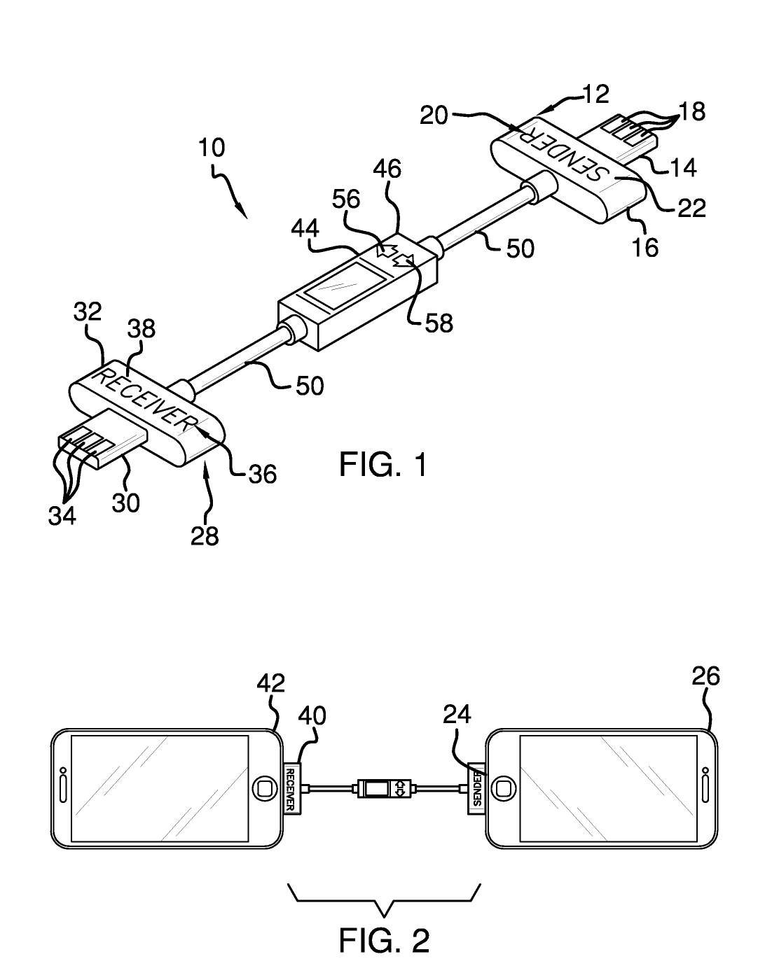

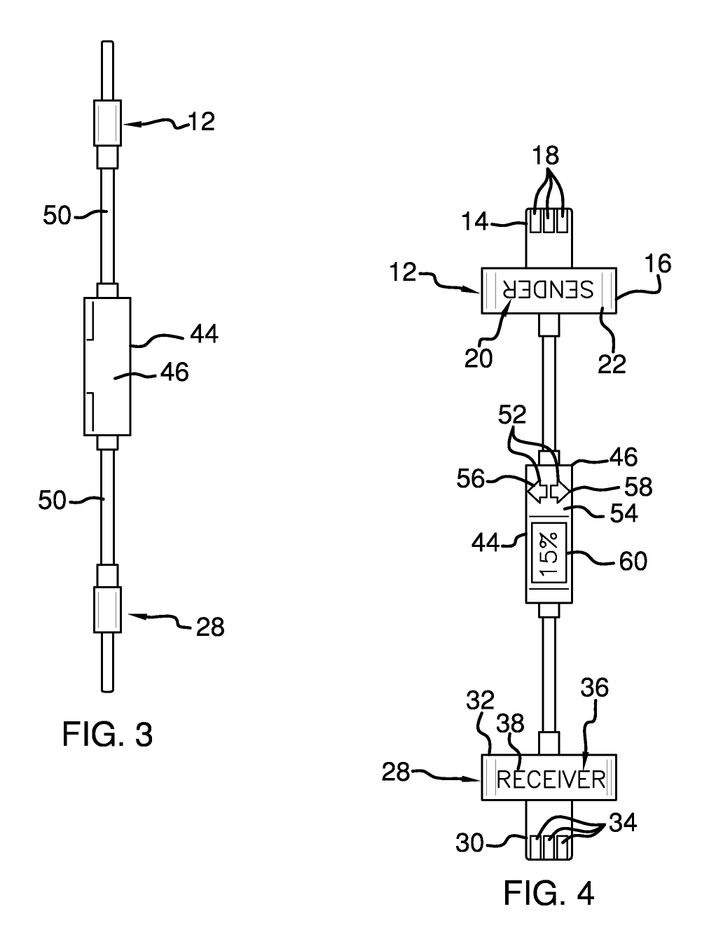

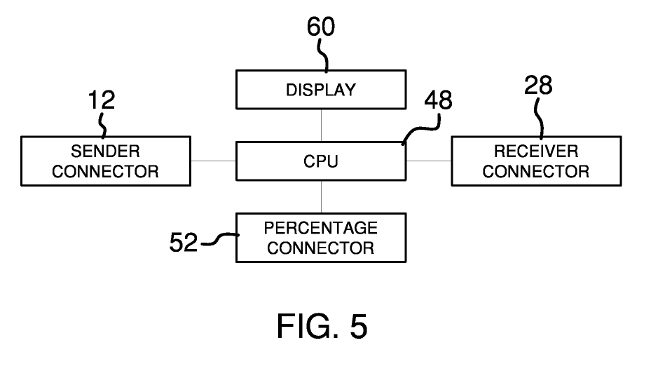

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the charging assembly 10 generally comprises a first coupler 12. The first coupler 12 comprises a connector 14 of the first coupler 12 extending forwardly away from a grip 16 of the first coupler 12. A plurality of contacts 18 is electrically coupled to the connector 14 on the first coupler 12. The plurality of contacts 18 on the first coupler 12 may each be comprised of an electrically conductive material. Indicia 20 is printed on an upper side 22 of the grip 16 on the first coupler 12. The indicia 20 may comprise the word “Sender”.

The connector 14 on the first coupler 12 is insertable into a charge port 24 on a first electronic device 26. The plurality of contacts 18 on the first coupler 12 is electrically coupled to the first electronic device 26. Additionally, the first electronic device 26 may be a Smart Phone of any conventional design.

A second coupler 28 is provided. The second coupler 28 comprises a connector 30 of the second coupler 28 extending forwardly away from a grip 32 of the second coupler 28. A plurality of contacts 34 is electrically coupled to the connector 30 on the second coupler 28. Each of the plurality of contacts 34 on the second coupler 28 may each be comprised of an electrically conductive material. Indicia 36 is printed on a topmost side 38 of the grip 32 of the second coupler 28. The indicia 36 may comprise the word “Receiver”.

The connector 30 on the second coupler 28 is insertable into a charge port 40 on a second electronic device 42. The plurality of contacts 34 is electrically coupled to the second electronic device 42. Moreover, the second electronic device 42 may be a Smart Phone of any conventional design.

A controller 44 is provided. The controller 44 has an outer wall 46. A processor 48 is coupled to the controller 44. The processor 48 may be an electronic processor of any conventional design.

A pair of conductors 50 is provided. Each of the pair of conductors 50 is electrically coupled between an associated one of the first 12 and second 28 couplers and the controller 44. The first 12 and second 28 couplers are in electrical communication with each other. An electrical current flows from the first coupler 12 to the second coupler 28 so the first electronic device 26 charges the second electronic device 42.

A pair of actuators 52 is coupled to a top side 54 of the outer wall 46 of the controller 44. Each of the pair of actuators 52 has an arrow shape. Each of the pair of actuators 52 is electrically coupled to the processor 48. An up one of the pair of actuators 56 is actuated to increase a rate of flow of the electrical current between the first 26 and second 42 electronic devices. A down one 58 of the pair of actuators 52 is actuated to decrease the rate of flow of the electrical current between the first 26 and second 42 electronic devices.

A display 60 is coupled to the top side 54 of the outer wall 46 of the controller 44.

The display 60 is electrically coupled to the processor 48. Additionally, the display 60 displays the rate of transfer of the electrical current between the first 26 and second 42 electronic devices. The display 60 may be an LCD display of any conventional design.

In use, the assembly 10 is used to charge the second electronic device 42 when no power source is available for charging. The first 12 and second 28 couplers are each coupled to the associated first 26 and second 42 electronic devices. The rate of charge is selected with the up 56 and down 58 actuators. The second electronic 42 device is charged off of the first electronic device 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging assembly configured to draw electricity from a first electronic device and deliver the electricity to a second electronic device, said assembly comprising:
a first coupler configured to be coupled to the first electronic device;
a second coupler configured to be coupled to the second electronic device;
a controller coupled between said first and second couplers, said controller controlling the transfer of the electricity between the first and second electronic devices;
a processor coupled to said controller; and
a display coupled to said controller, said display being operationally coupled to said processor, said display displaying an amount of charge being transferred between the first and second electronic devices.

2. The assembly according to claim 1, wherein said first coupler comprising a connector of said first coupler extending forwardly away from a grip of said first coupler.

3. The assembly according to claim 2, further comprising a plurality of contacts electrically coupled to said connector on said first coupler.

4. The assembly according to claim 3, further comprising said connector on said first coupler being insertable into a charge port on the first electronic device such that said plurality of contacts is electrically coupled to the first electronic device.

5. The assembly according to claim 1, wherein said second coupler comprising a connector of said second coupler extending forwardly away from a grip of said second coupler.

6. The assembly according to claim 5, further comprising a plurality of contacts electrically coupled to said connector on said second coupler.

7. The assembly according to claim 6, further comprising said connector on said second coupler being insertable into a charge port on the second electronic device such that said plurality of contacts is electrically coupled to the second electronic device.

8. The assembly according to claim 1, wherein said controller having an outer wall, said display being coupled to a top side of said outer wall of said controller, said display being electrically coupled to said processor.

9. The assembly according to claim 1, further comprising a pair of conductors, each of said pair of conductors being electrically coupled between an associated one of said first and second couplers and said controller such that said first and second couplers are in electrical communication with each other.

10. The assembly according to claim 9, wherein an electrical current flows from said first coupler to said second coupler such that the first electronic device charges the second electronic device.

11. A charging assembly configured to draw electricity from a first electronic device and deliver the electricity to a second electronic device, said assembly comprising:
a first coupler, said first coupler comprising a connector of said first coupler extending forwardly away from a grip of said first coupler;
a plurality of contacts electrically coupled to said connector on said first coupler;
said connector on said first coupler being insertable into a charge port on the first electronic device such that said plurality of contacts is electrically coupled to the first electronic device;
a second coupler, said second coupler comprising a connector of said second coupler extending forwardly away from a grip of said second coupler;
a plurality of contacts electrically coupled to said connector on said second coupler;
said connector on said second coupler being insertable into a charge port on the second electronic device such that said plurality of contacts is electrically coupled to the second electronic device;
a controller, said controller having an outer wall;
a pair of conductors, each of said pair of conductors being electrically coupled between an associated one of said first and second couplers and said controller such that said first and second couplers are in electrical communication with each other, an electrical current flowing from said first coupler to said second coupler such that the first electronic device charges the second electronic device;
a processor coupled to said controller; and
a display coupled to a top side of said outer wall of said controller, said display being electrically coupled to said processor, said display displaying an amount of charge being transferred between the first and second electronic devices.
